(19) United States
(12) Patent Application Publication
(10) Pub. No.: US 2018/0192678 A1
(43) Pub. Date: Jul. 12, 2018

(54) FOOD CONCENTRATE FOR SOUP, SAUCE OR GRAVY

(71) Applicant: Conopco, Inc., d/b/a UNILEVER, Englewood Cliffs, NJ (US)

(72) Inventors: Stephan Georg SCHUMM, Rotterdam (NL); Sabrina SILVA PAES, Delft (NL)

(73) Assignee: Conopco, Inc., d/b/a UNILEVER, Englewood Cliffs, NJ (US)

(21) Appl. No.: 15/737,528

(22) PCT Filed: Jun. 21, 2016
(86) PCT No.: PCT/EP2016/064278

§ 371 Date: Dec. 18, 2017

(30) Foreign Application Priority Data
Jun. 25, 2015 (EP) EP15173880.4

(51) Int. Cl. A23L 23/10; A23L 27/10; A23L 27/22; A23L 27/23; A23L 27/00; A23L 29/212

(52) U.S. Cl. CPC A23L 23/10; A23V 2250/628; A23L 27/22; A23L 27/235; A23L 27/82; A23L 29/212; A23V 2002/00; A23V 2200/16; A23V 2200/242; A23V 2250/032; A23V 2250/042; A23V 2250/0618; A23V 2250/5118; A23V 2250/606; A23V 2250/61; A23L 27/10

(57) ABSTRACT

A food concentrate substantially free from water is provided with high amounts of non-gelatinised starch without the need for sorbitol such that after dilution a sufficient viscosity is obtained in the ready-to-eat product.

### FIELD OF THE INVENTION

The present invention relates to food concentrates. Food concentrates like soup, gravy and sauce concentrates are food products designed to provide a for example ready-to-eat soup, gravy or sauce upon dilution in water and usually heating.

### BACKGROUND OF THE INVENTION

Starch is widely used in food products as a thickening agent. In the presence of sufficient water and when the temperature is high enough (usually more than 60° C.) the starch granules start to swell. This process, also referred to as gelatinisation, is usually characterised by the loss of the crystalline structure (order-disorder transition) that can be observed by several techniques such as X-ray diffraction, Differential Scanning calorimetry (DSC) (gelatinisation endothermic peak), and microscopy (loss of birefringence and granule swelling).

The native starches (i.e. unmodified) of different botanical sources differ in their appearance (granule form) and functional properties (e.g. pasting, viscosity). Most of the common starches are readily and unequivocally identifiable under a polarizing microscope, using the criteria of granule size and shape, form and positions (centric or eccentric) of the hilum (botanical centre of the granule) and brilliance of the interference cross under polarized light (Snyder, E M. (1984). Chapter XXII—Industrial microscopy of starches. In: Starch: Chemistry and Technology (Second Edition) Food Science and Technology, ed. R. L. W. PASCHALL San Diego: Academic Press, 661-673). For example, potato starches are characterised by large oval granules, tapioca starch by spherical-truncated granules and corn starch by round granules. Sago starch granules are typically oval shaped with smooth surface and show an off centre hilum. These shapes can be easily observed by light microscopy or scanning electron microscopy. (Method Starc.03-Starch Identification (Microscopy)-B25. Analytical Methods of the Member Companies of the Corn Refiners Association, Inc. 1991) Depending on the botanical source of the starch its thickening properties may differ.

Food technologists working with starches routinely apply two standard methods to analyse the gelatinisation behaviour and thickening properties of starches. The first one is the temperature when the gelatinisation starts: the Tonset (temperature of onset of gelatinisation). The industry standard for measuring Tonset is using Differential Scanning calorimetry (DSC) (Biliaderis et al. (1980). Starch gelatinisation phenomena studied by differential scanning calorimetry. Journal of Food Science 45, 1669-1674). As water is heated with starch granules, gelatinisation occurs, involving an endothermic reaction. DSC provides a quantitative measure of the heat flow associated with the starch gelatinisation, and the endothermic peaks observed are indicative of melting.

The second standard method measures the increase in viscosity is known in the art as a “pasting” curve. It allows to distinguish—inter alia—starches that thicken relatively fast from so called delayed swelling starches. Pasting curves are routinely measured by a Rapid Visco Analyser (RVA) (Biliaderis, C. G. (2009). Chapter 8 —Structural Transitions and Related Physical Properties of Starch. In: Starch (Third Edition) Food Science and Technology, ed. J. BeMiller and R. Whistler San Diego: Academic Press, 293-372). An RVA is a rotational viscometer that continuously records the viscosity of a sample under conditions of controlled temperature and shear which can be used to measure the increase in viscosity and to provide an assessment of starch ‘pasting’.

It has long been known that e.g. the thickening properties of a native starch of a botanical source can be modified chemically or physically. The most common chemical modification processes include acid treatment, cross-linking, oxidation, and substitution, including esterification and etherification. Physical modification methods involve the treatment of native starch granules under e.g. different temperature/moisture combinations, pressure, shear, and irradiation. Physical modification also includes mechanical attrition to alter the physical size of starch granules.

Native and modified starches have been used in sauces, gravies and soups. Many sauces, gravies and soups are sold as food concentrates like sachets of dry powdered sauce, gravy or soup concentrates. To prepare the ready-to-eat product the consumer usually dissolves these concentrates in an aqueous phase and applies a heating step to cook the starch. EP 0 835 614 A2 discloses emulsions with an unidentified non-gelatinised starch. WO 2005/074717 Al discloses concentrates with waxy corn starch or “heat moisture treated starch” of an unidentified type. GB 2 030 438 A discloses heat moisture treated (HMT) starches like HMT potato starch. U.S. Pat. No. 5,008,124 A discloses dry mixes with non-gelatinised starch.

A food concentrate will have a relatively high amount of starch depending on the dilution factor it has been designed for and the desired viscosity of the ready-to-eat product. A food concentrate designed to be diluted 10 times to prepare the ready-to-eat product will have a 10 times higher amount of starch than in the ready-to-eat products. These high amounts of starch in the concentrate may lead to lumping problems when the consumer tries to dilute the concentrates. Starches have been modified to decrease the lumping problem in dry or even pasty concentrates. For example, WO 2014/053287 and WO 2014/053288 disclose as most preferred starch native corn and heat moisture treated (HMT) potato starch for low lumping. It has been reported that using the proper dilution protocol low or even no lumping may be obtained with native corn starch and HMT potato starch.

EP 1602289 and WO 2004/049822 disclose the use of a non-gelatinised heat moisture treated potato starch in a shelf stable pasty concentrated composition in the presence of relatively high amounts of sorbitol. However, sorbitol is a not desirable ingredient for a gravy, soup or sauce In addition, a small subset of users have reported that concentrates with non-gelatinised heat moisture treated potato starch show unacceptable lumping.

Although the applicants do not wish to be bound by theory it is hypothesised that ump formation may be exacerbated if consumers do not strictly follow the instructions for the dilution of the concentrate by hardly stirring at all. While some starches show decrease in lumping at the same time these starches show little thickening effect in the ready to eat product.

Therefore, it would be desirable to provide a food concentrate with high amounts of starch without the need for sorbitol such that after dilution a sufficient viscosity is obtained in the ready-to-eat product. In addition, it would also be desirable to provide a more robust concentrate which shows a decreased lump formation during hot dilution. To provide such concentrates a more sensitive protocol was developed wherein even HMT potato starch resulted in undesirable lumping. WO 2014/009079 discloses gelled concentrates with starches with a low gelatinization temperature.

### SUMMARY OF THE INVENTION

Surprisingly, the present invention provides food concentrates which result in an improved reduction in lump formation combined with the desired viscosity in the end product. Accordingly the present invention provides a food concentrate preferably comprising
a) less than 20 wt % of water by weight of the total food concentrate;
b) 3 to 70 wt % of salt by weight of the food concentrate;
c) an effective amount of a taste booster selected from glutamate, 5′-ribonucleotides, sucrose, glucose, fructose, lactic acid, citric acid and mixtures thereof;
d) 8 to 75 wt % by weight of the total food concentrate of a delayed-swelling annealed non-gelatinised starch characterised by Ref Tonset of at least 70° C.;

The present invention provides a food concentrate preferably comprising
a) less than 20 wt % of water by weight of the total food concentrate;
b) 3 to 70 wt % of salt by weight of the total food concentrate;
c) an effective amount of a taste booster selected from glutamate, 5′-ribonucleotides, sucrose, glucose, fructose, lactic acid, citric acid and mixtures thereof;
d) 8 to 75 wt % of non-gelatinised annealed sago starch and/or non-gelatinised annealed corn starch by weight of the total food concentrate;

In addition the present invention provides a process for preparing a concentrate according to the invention, a process for using a concentrate according to the invention to prepare a ready-to-eat product, a ready-to-eat product obtainable by diluting a concentrate according to the invention and the use of concentrate according to the invention to prepare a ready-to-eat product.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages by weight of the total food concentrate unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

Food Concentrate

The food concentrate according to the invention is designed to provide a ready-to-eat product after an appropriate dilution and heating with an aqueous phase such that the starch provides the desired viscosity in the ready-to-eat product. The term dilution in this respect is intended to include dissolving and dispersing as these take place concurrently. The ready-to-eat product is preferably a soup, gravy or a sauce. The sauce may be part of dish like a stew or a risotto. The dilution of a food concentrate according to the invention is usually between 20 g/L and 350 g/L and more preferably between 50 and 250 g/L. The term “food concentrate” and “concentrate” are used interchangeably.

The level of water, salt, starch and other taste ingredients in the food concentrate are determined by the desired level in the ready-to-eat product and the dilution rate. The amount of salt in the food concentrate and intended dilution rate is preferably such that after the dilution the level of salt is preferably at least 0.25 wt %, more preferably at least 0.5 wt %, more preferably at least 0.7 wt % and at preferably at most 2 wt %, more preferably at most 1.7 wt %, more preferably at most 1.3 wt % by weight of the total water content of the ready-to-eat product. The amount of starch in the food concentrate and intended dilution rate is preferably such that after the dilution the amount of starch in the ready-to-eat product is preferably at least 1 wt %, preferably at least 2 wt %, most preferably at most 6 wt %, preferably at most 7 wt % by weight of the total water content of the ready-to-eat product. The total amount of water present in the ready-to-eat product is preferably at least 50 wt %, more preferably at least 65 wt %, more preferably at least 75 wt % and preferably less than 97 wt %, preferably less than 95 wt % preferably less than 90 wt % by weight of the total food concentrate. (Water may be added as such or as part of other ingredients like cream or milk). Taste ingredients include fat and creamer. Creamer may be present in amounts of 10 to 60 wt % by weight of the total food concentrate. Details and other preferred ranges of salt, starch, water and other ingredients are described below.

Starch

Surprisingly, it was found that food concentrates according to the invention can be successfully formulated with a specific physically modified non-gelatinised starch. The non-gelatinised starch of the present invention is usually a delayed-swelling physically modified starch having a Ref Tonset of at least 70° C., preferably a delayed-swelling annealed starch having a Ref Tonset of at least 70° C.

Ref Tₒₙₛₑₜ Measured by Differential Scanning Calorimetry (DSC)

Tₒₙₛₑₜ of a given starch is measured by measuring the gelatinisation of starch in a reference DSC-solution or water. The latter is adjusted to reflect the product application. For example if the product application would be a sweet pudding, the reference DSC-solution will have correspondingly high amounts of sugar. For the present invention the reference DSC-solution (Ref DSC-solution) is demineralised water and the Tₒₙₛₑₜ measured in this reference Ref DSC-solution is referred to the Ref Tₒₙₛₑₜ.

The preferred physically modified starches show a characteristic increase in Ref Tₒₙₛₑₜ compared to the native starch of the same botanical source. In addition to the Ref Tₒₙₛₑₜ determined in the Ref DSC solution, the Tₒₙₛₑₜ may also be determined in the concentrate (Prod Tₒₙₛₑₜ). The increase in the Ref Tₒₙₛₑₜ of a physically modified starch like annealed starch can also be found by comparing the Prod Tₒₙₛₑₜ of the physically modified starch to the Prod Tₒₙₛₑₜ of the native starch of the same botanical source, in the same composition.

Delayed-Swelling Starches as Determined by Pasting Curve

Pasting curves are measured by a Rapid Visco Analyser (RVA)—a rotational viscometer that continuously records the viscosity of a sample under conditions of controlled temperature and shear which can be used to measure the increase in viscosity and provide an assessment of starch ‘pasting’. For the purpose of the present invention delayed-swelling starches are defined according the test described in detail below.

The non-gelatinised starch of the present invention is preferably obtained by a physical modification of native starch like annealing and/or heat moisture treatment. The non-gelatinised starch used in the invention is preferably an annealed starch. Annealed starch can be obtained by annealing starch as known in the art e.g. from Tester, R. F. and Debon, S. J. J. Annealing of starch—a review. International Journal of Biological Macromolecules, 27, 1-12. 2000. Briefly, annealing of starch may be described as a physical treatment whereby the starch is incubated in excess water (e.g. >60% w/w) or intermediate water content (e.g. 40 to 55% w/w) at a temperature between the glass transition temperature and the gelatinisation temperature for a certain period of time. After the annealing process, the starch granules remain non-gelatinised. Preferred annealed starches are delayed swelling starches, preferably with a Ref Tₒₙₛₑₜ of at least 70° C., more preferably of at least 72° C., more preferably of at least 74° C., more preferably of at least 75° C., most preferably at least 76° C., and preferably at most 100° C., more preferably at most 95° C.

A delayed swelling physically modified starch like a delayed swelling annealed starch according to the invention may be prepared with a process comprising the following steps:
a) Heating a water slurry of non-gelatinised native starch (excess water, preferably with a (w/w) ratio of water : starch of higher than 2:1 more preferably higher than 3:1) to a temperature of from e.g. 55 to 68° C. and kept to this temperature for a period of at least 2 h, preferably at least 3 h, preferably less than 24 h. This step can be performed under mild stirring. The temperature should be maintained below the Tonset of the starch in the aqueous slurry so the starch remains non-gelatinised during the process, as known by a person skilled in the art.
b) Removing the excess water (e.g. by sedimentation and filtering) and drying the starch at a temperature and conditions such that it remains non-gelatinized. (e.g. vacuum dried, T<60° C.)

Optionally the heating step a) can be performed in multiple phases of e.g. increasing temperature to obtain a higher shift in the onset of gelatinization and prevent any unwanted starch gelatinization at the beginning of the process, specially for starches which have a natural lower Tonset. For example 1 h at 60° C. followed by one hour at 63° C. followed by one hour at 65° C. etc.

Optionally, the heating step a) may be carried out in a salt containing solution or another swelling inhibit agent e.g. at least 15% NaCl, preferably at least 20 wt % NaCl by weight of the starch-water slurry whereby the slurry is heated to a temperature of from 60 to 73° C. whereby the remaining conditions are as described above.

Although it is not preferred, the starch may be further modified by any means known in the art.

The non-gelatinised starch in the concentrate of the invention can be isolated from the concentrate by diluting the concentrate in water at a temperature below the gelatinisation temperature of the starch e.g. 50-60° C. Ref Tₒₙₛₑₜ and delayed swelling of the isolated non-gelatinised starch can be characterised as described herein.

An annealed non-gelatinised starch useful in the invention may also be modified by an additional physically modification like heat moisture treatment. Annealing and physical modification are well known in the art (Stute, R. (1992). Hydrothermal Modification of Starches: The Difference between Annealing and Heat/Moisture-Treatment.

Starch/Starke 44, 205-214; Annealing of starch—a review. International Journal of Biological Macromolecules 27, 1-12.)

The non-gelatinised starch used in the invention preferably has an average diameter of more than 10 micrometer, more preferably more than 12 micrometer, more preferably more than 15 micrometer, most preferably more than 18 micrometer. Starch granule size can be measured for example by suspending the non-gelatinised starch granules in water and observing the granule sizes by light microscopy or a particle size analyzer as known by person skilled in the art. Starch granules have sizes ranging from invisible under light microscope to up to more than 100 micrometers. For estimating the average granule size by using light microscopy, for example, images from separate areas each with at least 200 starch granules are randomly recorded. Three images are used to measure starch granules sizes. The starch granules are labelled manually, and the sizes are automatically measured in micrometers by suitable image analysis software. Further details can be found in Snyder, E M. (1984) as cited above.

The non-gelatinised starch used in the invention is preferably from the following botanical source: corn, arrowroot, sago, waxy corn, wheat, tapioca, yam and mixtures thereof. Most preferably the starch is annealed sago starch. Annealed sago starch is well known in the art (Wang, W. J., Powell, A. D., and Oates, C. G. (1997). Effect of annealing on the hydrolysis of sago starch granules. Carbohydrate Polymers 33, 195-202; Jayakody, L. and Hoover, R. (2008). Effect of annealing on the molecular structure and physicochemical properties of starches from different botanical origins: A review. Carbohydrate Polymers 74, 691-703).

The amount of non-gelatinised starch is at least 8 wt %, more preferably at least 10 wt % and 12 wt %, more preferably at least 15%, more preferably at least 20%, preferably at most 75 wt % more preferably at most 70 wt %, more preferably at most 65 wt % more preferably at most 60 wt %, most preferably at most 55 wt % by weight of the total concentrate. The food concentrate according to the invention preferably has a w/w ratio of non-gelatinised starch (on dry basis) to salt of higher than 0.3, preferably higher than 0.5, preferably higher than 0.8, more preferably higher than 1, more preferably higher than 1.5, most preferably higher than 2. The ratio w/w ratio of non-gelatinised starch (on dry basis) to salt is preferably at most 30, more preferably at most 20, more preferably at most 15, more preferably at most 10, more preferably at most 8, more preferably at most 6, more preferably at most 5. Although starch may contain some water depending on the source, the amounts in the present invention are calculated as the dry matter. The w/w ratio of non-gelatinised starch to salt in the total food concentrate is preferably at least 0.8, even more preferably at least 1, even more preferably at least 1.5, even more preferably at least 2, and more preferably at most 10, more preferably at most 8, most preferably at most 5.

It is understood that the preferred features of the non-gelatinised starch used in the invention as described can be combined, i.e. preferred botanical source with preferred physical modification, preferred Ref Tonset and delayed swelling.

Reduction in Lumping

Preferably, the concentrate according to the invention has a reduction in lumping in the test described below of preferably at least 15%, more preferably at least 20%, more preferably at least 30%, more preferably at least 40%, more preferably at least 50% and preferably at most 100% when compared to the same concentrate except that the starch according to invention is replaced by the native starch from the same botanical source. For example: Lumping reduction (in %)=(1—Lumping in composition with annealed sago/Lumping in composition native sago)*100. Thus, if a concentrate with native sago results in 80% lumping and the same concentrate with annealed sago in 10% lumping, the reduction in lumping is 87.5% ((1-10/80)*100%). A reduction in lumping of x% as described herein may also referred to as a Reduced Lumping Factor (RLF) of x. Accordingly, the concentrate according to the invention has a RLF of preferably at least −15, more preferably at least −20 more preferably at least −30, more preferably at least −40, more preferably at least −50 and preferably at most −100.

Viscosity of the Ready-to-Eat Product

Preferably the food concentrate according to the invention provides a ready-to-eat product having viscosity of at least 10 mPa·s, preferably at least 20 mPa·s preferably more preferably at least 30 mPa·s, most preferably at least 50 mPa·s at 60° C. The viscosity is preferably measured as detailed below.

Water

The food concentrate is preferably substantially free from water, i.e. having less than 20 wt %, more preferably less than 15% more preferably less than 10%, more preferably less than 8 wt %, most preferably less than 5 wt % of water by weight of the total food concentrate. In the context of the present invention the total water content in the food concentrate includes both water added as such and water as part of other ingredients like vegetables, unless otherwise indicated. The water content in the food concentrate can be measured by any standard method including drying the food concentrate and comparing the weight before and after drying.

Sorbitol

Surprisingly, no sorbitol is needed. Preferably, the food concentrate according to the invention comprises less than 5 wt %, preferably less than 3 wt %, more preferably less than 1 wt %, more preferably less than 0.1 wt % of a sorbitol by weight of the total food concentrate. Most preferably, no sorbitol is present at all. It is understood that the expression “less than” includes 0 wt %.

Salt

The food concentrate preferably comprises at least 3 wt %, more preferably at most 70 wt % of salt, by weight of the total food concentrate. Salt is added to provide a salty taste. The salt preferably comprises NaCl, KCl and mixtures thereof. The high level of salt is predominantly present to provide the desired salty taste impact after dissolution in a relatively high volume. Preferably, the amount of salt in the food concentrate is at least 3 wt %, preferably at least 5 wt %, preferably at least 8 wt %, preferably at least 10 wt %, more preferably at least 15 wt %, even more preferably at least 20 wt %. Preferably, the amount of salt is at most 70 wt %, more preferably at most 60 wt %, more preferably at most 50 wt %, most preferably at most 40 wt %, by weight of the total food concentrate. Preferably, the amount of NaCl in the food concentrate is at least 3 wt %, preferably at least 5 wt %, preferably at least 10 wt %, preferably at least 15 wt % and preferably at most 60 wt %, more preferably at 55 wt %, most preferably at most 50 wt %, by weight of the total food concentrate. The food concentrate according to the invention preferably has a water activity of less than 0.65, preferably less than 0.5, more preferably less than 0.4, more preferably less than 0.3 and preferably more than 0.15.

Savoury Taste Booster

The food concentrate is preferably a savoury food concentrate, for example for preparing a bouillon, a soup, a sauce, a gravy or a seasoned dish. To contribute to the savoury taste, the food concentrate of the present invention may further comprise a savoury taste booster selected from the group consisting of glutamate, 5′-ribonucleotides, sucrose, glucose, fructose, lactic acid, citric acid and mixtures thereof. The term savoury taste booster used in the singular may refer to a single compound or a mixture of more than one taste booster compounds. The term “savoury taste booster” is used interchangeably with the term “taste booster”. The amount of savoury taste booster present in the food concentrate is present in an effective amount to obtain the desired level in the ready-to-eat product. The effective amount depends on the desired dilution rate and amount in the ready-to-eat product. The amount of savoury taste booster in the concentrate is preferably present in an amount of at most 40 wt %, more preferably of at most 30 wt %, more preferably in an amount at most 25 wt %, most preferably in an amount of at most 15 wt %, and preferably at least 0.1 wt %, more preferably at least 0.5 wt %, more preferably at least 1 wt %, more preferably at least 5 wt %, based on the weight of the total food concentrate. A savoury taste booster as mentioned above may be present in an amount at most 40 wt %, more preferably of at most 30 wt %, more preferably in an amount at most 25 wt %, most preferably in an amount of at most 15 wt %, and preferably at least 0.1 wt %, more preferably at least 0.5 wt %, more preferably at least 1 wt %, more preferably at least 5 wt %, based on the weight of the total food concentrate. It is understood that any savoury taste booster compound can be added as such or as part of more complex food ingredients like yeast extract; hydrolyzed proteins of vegetables-, soy-, fish-, or meat-origin, malt extract, beef flavourings, onion flavouring, liquid or dissolvable extracts or concentrates selected from the group consisting of meat, fish, crustaceans, herbs, fruit, vegetable and mixtures thereof.

A food concentrate according to the invention preferably comprises
a) less than 20 wt % of water by weight of the total food concentrate;
b) 3 to 70 wt % of salt by weight of the total food concentrate;
c) 1 to 40 wt % by weight of the total food concentrate of a taste booster selected from glutamate, 5′-ribonucleotides, sucrose, glucose, fructose, lactic acid, citric acid and mixtures thereof;
d) 10 to 75 wt % by weight of the total food concentrate of a delayed-swelling annealed non-gelatinised starch characterised by Ref Tonset of at least 70° C.; wherein the non-gelatinised starch is annealed sago starch and/or annealed corn starch;
e) having a w/w ratio of non-gelatinised starch to salt in the total food concentrate of 1 to 5;
f) having a water activity of less than 0.4 more preferably less than 0.3 and more than 0.15;
wherein the food concentrate provides a ready-to-eat product having viscosity of, preferably at least 20 mPa·s, more preferably at least 30 mPa·s, most preferably at least 50 mPa·s at 60° C., wherein said ready-to eat product is a soup, sauce or gravy.

Process of Preparing a Food Concentrate

In a further aspect, the invention relates to a process for preparing a food concentrate as described herein, preferably comprising
a) less than 20 wt % of water by weight of the total food concentrate;
b) 3 to 70 wt % of salt by weight of the total food concentrate;
c) an effective amount of a taste booster selected from glutamate, 5′-ribonucleotides, sucrose, glucose, fructose, lactic acid, citric acid and mixtures thereof;
d) 8 to 75 wt % of a delayed-swelling annealed non-gelatinised starch characterised by Ref Tonset of at least 70° C.;
   the process comprising the steps of:
i) preparing a mixture comprising:
   the salt, taste booster and the non-gelatinised starch
ii) optionally, filling the mixture of step iii) into a packaging; and

A package preferably is a package selected from the group consisting of a sachet, a tub, a cup, a jar, a doy pack and a stick pack. Preferably, the concentrate is a packaged concentrate, whereby the concentrate (excluding the packaging) has weight of at least 10 g, preferably at least 20 g, preferably less than 1 kg, more preferably less than 50 g. Preferably, the concentrate is unit dosed having a weight of at least 10 g and less than 50 g.

The present invention also relates to a food concentrate obtainable by the process as described above.

Use

Preferably, the invention relates to the use of the food concentrate of the present invention to prepare a soup, a sauce or a gravy. At least part of the concentrate is preferably mixed with an aqueous phase and diluted in it. The term “dilution” is used interchangeably with the terms “dissolving” and “dispersing” and encompasses both. If preferred, the concentrate of the present invention can be added to a pan directly with sufficient amount of water. Optionally other ingredients required for the soup, sauce or gravy can be added before or after the concentrate like vegetables and/or meat. However, to calculate the amount of salt and starch in the ready-to-eat product such solid ingredients are excluded because the salt and starch will mainly dissolve in the aqueous phase only. Preferably, the temperature of the aqueous phase is between 60° C. and 95° C., more preferably of between 70 and 90° C. During dilution, but preferably thereafter, the mix of the concentrate of the present invention and the aqueous phase is preferably heated or heating is continued to cook-up the mixture. Continuous heating improves dissolving of the concentrate and induces the viscosity increase as a consequence of gelatinisation of the starch. It might be preferred that the concentrate is first dissolved in the aqueous phase, preferably in water, of a temperature of below 95° C., before cooking up (bringing it to a boil). Cooking up is preferred to achieve the final viscosity. A preferred cooking time may be between 20 s and 10 min, preferably between 30 s and 8 min, more preferably between 45 s and 5 min, preferably at boiling temperature.

A person of average skill is able to optimize the food concentrate depending on the preferred preparation mode or preparation requirements or the desired application for the consumer. For example a food concentrate for a stew may be simmered for hours.

Hence, preferably the present invention relates to a process to provide a ready-to-eat food product, comprising the steps of:
a) providing a food concentrate of the present invention,
b) admixing at least part of the food concentrate to an aqueous phase,
c) heating the mixture resulting from step b) to a temperature higher than the Ref Tₒₙₛₑₜ of the starch used, such as to achieve a viscosity increase of the mixture to result in a ready-to-eat food product, whereby the dilution in step b) is preferably between 20 g/L and 350 g/L and more preferably between 50 and 250 g/L. Preferably the heating step bringing the mixture to boiling temperature as described above.

The present invention also relates to a ready-to-eat food product obtainable by the process as described above.

Tests

I Ref Tₒₙₛₑₜ: Reference Temperature of Onset of Gelatinisation of Starch in Reference Solution

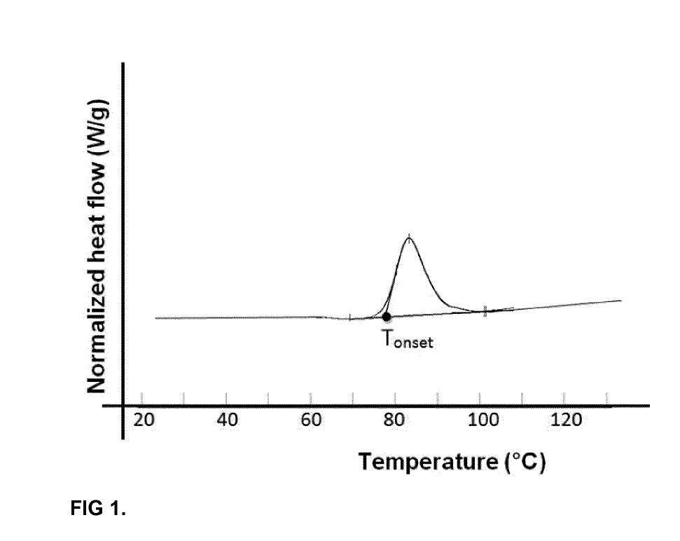

As mentioned above a person skilled in the art of starch routinely uses Differential Scanning calorimetry (DSC) to measure the Tₒₙₛₑₜ of a given starch sample to evaluate its gelatinisation properties. A typical DSC curve and the Tₒₙₛₑₜ according to this procedure is shown in FIG. 1 (Temperature vs Normalized heat flow, with endothermic events pointing upwards on the y axis)

The Ref Tₒₙₛₑₜ is the Tₒₙₛₑₜ measured in a reference solution, preferably measured using a Differential Scanning calorimetry (DSC) comprising the steps of:
preparing a mixture of 12 to 16 mg of starch and 40-50 μL of Ref DSC-solution resulting in a w/w ratio of 1:2.5 to 1:3 in a DSC sample pan (60 μL high pressure stainless steel) whereby the Ref DSC-solution is demineralised water.
carrying out the DSC measurement protocol comprising the steps of
   1. Holding the mixture for 3 min at 15° C.
   2. Heating said mixture from 15° C. to 120° C. at 10° C./min
using the standard DSC software to determine the Ref Tₒₙₛₑₜ from the onset of the peak indicating the thermal transition of starch gelatinisation in the DSC thermogram.

The equipment used for the DSC analysis can be any suitable calibrated DSC equipment and is preferably the Perkin Elmer Power Compensated DSC8000 equipped with an intracooler 3 as used herein. Preferably the DSC measurement is performed under nitrogen atmosphere with a gas flow of 20 mL/min.

In addition to the Ref Tₒₙₛₑₜ determined in the Ref DSC solution, the Tₒₙₛₑₜ may also be determined in the concentrate (Prod Tₒₙₛₑₜ). The difference between the Ref Tₒₙₛₑₜ compared for a native and a modified annealed starch of the same botanical origin will be reflected in the Prod Tₒₙₛₑₜ of the same two starches in a given formulation.

Therefore, the Prod Tₒₙₛₑₜ is measured in a similar way as the Ref Tₒₙₛₑₜ using a

Differential Scanning calorimetry (DSC) comprising the steps of:
preparing a mixture of 15 to 20 mg of concentrate and 35-45 μL of demineralised water resulting in a w/w ratio of 1:2.5 to 1:3 in a DSC sample pan (60 μL high pressure stainless steel).
carrying out the DSC measurement protocol comprising the steps of
   1. Holding the mixture for 3 min at 15° C.
   2. Heating said mixture from 15° C. to 120° C. at 10° C./min
using the standard DSC software to determine the Prod Tonset from the onset of the peak indicating the thermal transition of starch gelatinisation in the DSC thermogram.

II Delayed Swelling.

As mentioned above a delayed swelling starch can be determined using a Rapid Visco Analyser (RVA, Newport) with the standard RVA-software to establish a pasting curve as described below. During an RVA analysis, the starch is heated in an aqueous environment following a pre-defined temperature profile. The viscosity changes produced by heating and cooling starch in water generally provide a characteristic curve depending on the starch type and modification.

For the purpose of this invention, a starch is defined as a delayed swelling starch by analysing it using a Rapid Visco Analyser (RVA), whereby the RVA analysis comprises the steps of
i. Adding a suitable amount of starch to 25 g of Ref-RVA Solution, said amount of starch adjusted to provide an increase of viscosity to 180-320 cP at time=7 min (Visc(7)) calculated from the base line viscosity Visc(BL) at time=1 min, whereby the Ref RVA-solution contains 1.3 wt % NaCl, 0.8 wt % sucrose and 97.9 wt % water;
ii. Carrying out the RVA test under “STD1” conditions as described below or similar;
iii. Determining the ViscRef defined as Visc (7)−Visc(BL) expressed in centiPoise (cP), whereby the ViscRef is between 180-320 cP
iv. Determining T1 defined as the time necessary to first achieve ViscRef (starting t=1 min) and T2 defined as the time necessary to achieve half of the ViscRef (starting t=1 min)

Whereby the starch is defined as a delayed swelling starch if
a) T1 is preferably at least 6.5 min, more preferably at least 6.8 min, most preferably at least 7 min; and
b) T2 is preferably at least 4.6 min, more preferably at least 4.9 min, even more preferably at least 5 min, most preferably at least 5.1 min.

For the present invention the Ref RVA-solution is representative of a typical salt and sugar concentrations in the ready-to eat product.

The RVA standard analysis (STD1) test conditions (available in the standard equipment software package (Thermocline for Windows, TCW. Newport Scientific) can be described as:

| Time | | | |
|---|---|---|---|
| h:min:s | Type | Value | |
| 00:00:00 | Temperature | 50° | C. |
| 00:00:00 | Speed | 960 | rpm |
| 00:00:10 | Speed | 160 | rpm |
| 00:01:00 | Temperature | 50° | C. |
| 00:04:42 | Temperature | 95° | C. |
| 00:07:12 | Temperature | 95° | C. |
| 00:11:00 | Temperature | 50° | C. |

Profile End Time: 00:13:00
Profile Idle Temp: 50° C.

The amount of starch to be added to the Ref RVA-solution to achieve ViscRef can be easily adjusted by a person skilled in the art, for example by testing a range of amounts of starch added to the Ref RVA-Solution and obtaining ViscRef between 180-320 cP. The suitable amount of starch for the RVA analysis is preferably 0.8 to 2 g. Typical ranges of the starch amounts to be tested are:
Sago starch native and modified: 0.9-1.7 g
Tapioca starch native and modified: 0.8-1.4 g
Corn starch native and modified: 1.0-1.8 g

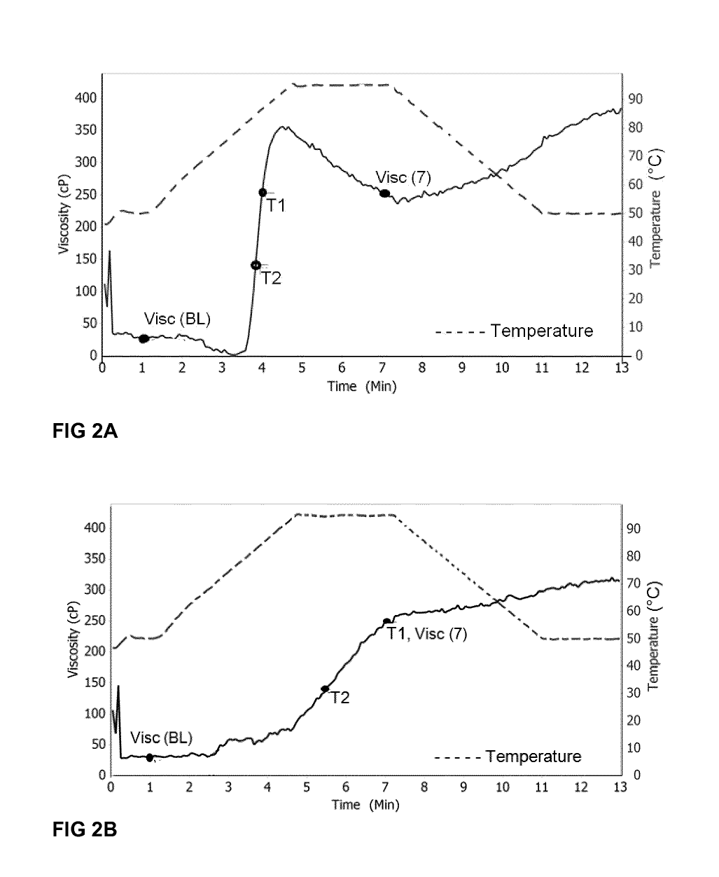

As an example pasting curves are shown in FIG. 2 of a native sago starch without delayed swelling (FIG. 2A) and a delayed swelling annealed sago starch (FIG. 2B):
Visc (BL)=viscosity at time=1 min (in cP)
Visc (7)=viscosity at time=7 min (in cP)

T1 defined as the time necessary to first achieve ViscRef (starting t=1 min) and T2 defined as the time necessary to achieve half of the ViscRef (starting t=1 min)

The characteristic delayed swelling of the starch can also be measured in the concentrate. For this purpose, a suitable amount of the concentrate (e.g. 3-5 g) should be added in 25 g of water (diluted) in order to provide a suitable amount of starch (e.g. 0.8-2 g) to provide an increase of viscosity of 180-320 cP at time=7 min calculated from the base line viscosity Visc(BL) at time=1 min. The amount of concentrate to be added to 25 g of water will depend on the type of starch and amount of starch present in the concentrate and can be easily adjusted by a person skilled in the art, for example by testing a range of amounts of concentrate added to 25 g of water. The characteristic delayed swelling of the starch in a food concentrate can be measured using a method comprising the following steps of:
i. Adding a suitable amount of concentrate to 25 g of water, said amount of concentrate adjusted to provide an increase of viscosity to 180-320 cP at time=7 min calculated from the base line viscosity Visc(BL) at time=1 min
ii. Carrying out the RVA test under “STD1” conditions as described above or similar;
iii. Determining the ViscRef defined as Visc(7)−Visc(BL) expressed in centiPoise (cP), whereby the ViscRef is between 180-320 cP
iv. Determining T1 defined as the time necessary to first achieve ViscRef (starting t=1 min) and T2 defined as the time necessary to achieve half of the ViscRef (starting t=1 min)

Whereby the T1 and T2 are as defined supra.

Standardised Wet Lumping Test

For the purpose of the present invention lumping of a concentrate according to the invention is preferably measured in the test below. The chosen test conditions favour the formation of lumps, i.e. adding the gelled concentrate in boiling water and with very mild stirring. This will allow to provide preferred food concentrates according to the invention which are more robust in use, even when consumers deviate from the instructions of use.
A kitchen food preparation machine (Kenwood Cooking chef major KM070 series or similar), with temperature control with major sized Anchor Flexi beater stirrer attachment or similar.
Stirrer moves at a stirring speed of ˜22 rotations per minute
25-30 g of food concentrate is added to 250 ml of water at 98° C. in the Kenwood Mixer
Stirring is continued for 1 min at 98° C.
Stirring is stopped and product is maintained for 1 min at 98° C. Product is sieved and amount undissolved material is weighed (1 mm mesh sieve)

The concentrate according to the invention used in this lumping test is without particles of vegetable, meat or herbs or other solid ingredients with a size larger than the mesh (1 mm) and that would remain in the sieve.

$$Standardised wet lumping ( \% material undissolved ) = \frac{weight material undissolved}{weight of initial concentrate} * 100$$

It is understood that the % of material undissolved can be higher than 100% in cases in which the amount of material retained in the sieve is higher than the initial amount of concentrate (e.g. 25 g concentrate is tested and the amount weighed in the sieve is 28 g). That is because the starch lumps also absorb water during cooking and that would be reflected in the amount retained in the sieve. The preferred non-gelatinised starch used in the invention shows a surprising decrease in lumping compared to the same concentrate with the same amount of native starch of the same botanical source.

Since the lumping test overestimates the lumping, it is expected that in real use including the addition of the concentrate to water at lower temperatures and/or e.g. intensive stirring with a hand whisk, as can be expected from some consumers, would lead to far lower absolute amount of lumps. However, a difference between preferred starches that are part of the invention and native starches of the same botanical source that are not part of the invention would still be observed.

Viscosity of the Ready-to-Eat Product

It is desirable that the ready-to-eat product obtained after diluting the food concentrate according to the invention has a certain viscosity. The viscosity of ready-to-eat product is preferably measured as detailed below.

Dilute the concentrate in the required amount of warm water of 60° C. to obtain the ready-to-eat product (e.g. 28 g concentrate in 250 g water). Stir well and then heat the product for 1 min at 98° C., assuring that no water evaporates during the preparation. For the measurement of the viscosity of the ready-to-eat product the product is prepared under mild conditions so no lumps are present (i.e. recommended water temperature and suitable stirring). As some starches will take more time to reach full viscosity, the same experiment is repeated with stirring and heating for 5 respectively 10 minutes and the highest viscosity measured is noted.

The viscosity is measured in a Physica MCR rheometer 300, 301 (Anton Paar GmbH, Graz, Austria) or similar, with the following geometry:
Measuring cup (ridged cylinder): Part number 21736
Vane: Part number. 21888 ridged cylinder

Method:
1) Equilibration step: Shear rate at 30 s⁻¹ at 75° C. for 2 min
2) Cooling step: Shear rate at 30 s⁻¹ from 75° C. to 20° C. at 2.04 ° C./min
If necessary, a solvent trap should be used during the measurement to avoid water evaporation.

The viscosity at 60° C. on cooling is recorded as and expressed in mPa·s. (milli Pascal second).

### EXAMPLES

The invention is further exemplified in the examples below. A savoury flavour mix was used to add savoury taste booster compounds to the concentrates.

### Example 1

Food concentrate with a delayed swelling annealed starch according to the invention for preparing creamy mushroom sauce

| | | Ex 1b (comp) |
|---|---|---|
| | | Based on a |
| | | commercial |
| | | product |
| | Ex 1a | Heat moisture |
| | Annealed Sago | treated potato |
| Ingredient (wt %) | (S2) | (S3) |
| Non-gelatinised starch | 18.8 | 18.8 |
| Salt | 7.6 | 7.6 |
| Savour flavour mix# | 27.5 | 27.5 |
| Creamer | 43.8 | 43.8 |
| Fat | 2.3 | 2.3 |
| Total (%) | 100.0 | 100.0 |

#powders: wine extract, flavourings, onion, yeast extract, lemon, pepper, sugar

The food concentrate of Example 1a with the delayed swelling annealed starch according to the invention (ex Ingredion Inc USA) showed a 72% a reduction in lumping (28 g of concentrate diluted in 250 ml water at 80° C.) compared to the same composition wherein the inventive starch was replaced by native sago starch (S1). When diluted in a separate experiment using the wet lumping protocol described above at 98° C.—when lumping is generally exacerbated - the reduction was 51%. The lumping of ex 1a with the inventive starch was also compared to example 1b (Comparative) which was based on a commercial product with the same amount of heat moisture treated potato starch. Compared to the commercial product a reduction in lumping was obtained of 51% at 80° C.

Starch Characterization:

RefTonset was measured as described above in demineralised water. RVA was measured as described herein whereby 1.2 g of each starch was used.

| | RVA | | | | DSC |
|---|---|---|---|---|---|
| | ViscRef | T1 | T2 | Delayed | RefTₒₙₛₑₜ |
| | (cP) | (min) | (min) | swelling | (° C.) |
| Sago (S1) | 280 | 3.9 | 3.8 | No | 70 |
| Annealed sago (S2) | 252 | 7.1 | 5.8 | Yes | 76 |
| Heat moisture | 283 | 7.1 | 6.1 | Yes | 63 |
| treated potato (S3) | | | | | |

### Example 2

A delayed swelling annealed starch according to the invention was prepared with the following process.
A water slurry of non-gelatinised native sago starch (excess water, e.g. 4-5% wt starch) was heated to a temperature of 64° C. and kept (incubated) to this temperature for about 2 h or about 3 h. This step can be performed under mild stirring.
The excess water was removed (e.g. by sedimentation and filtering) and the starch was dried at temperature and conditions to remain non-gelatinized. (e.g. vacuum dried, T<60° C.)

Starch Characterization

The annealed sago starch was analysed using RVA and DSC as described above. For the RVA analysis respectively 1.1 g annealed sago starch was used.

| | RVA | | | | DSC |
|---|---|---|---|---|---|
| | ViscRef | T1 | T2 | Delayed | RefTₒₙₛₑₜ |
| | (cP) | (min) | (min) | swelling | (° C.) |
| Annealed sago | 235 | 6.9 | 5.1 | Yes | 81° C. |
| (S10) | | | | | |

A gravy concentrate with the annealed sago starch showed low lumping upon dilution and the ready-to-eat product had a good viscosity.

### Example 3

A food concentrate for preparing creamy mushroom sauce was made with a delayed swelling annealed non-gelatinised starch according to the invention. It was compared to the same composition with non-gelatinised native corn starch (comparative).

| | Ex 3a | Ex 3b (comp) |
|---|---|---|
| Ingredient (wt %) | Annealed Sago (S2) | Native corn starch |
| Non-gelatinised starch | 18.8 | 18.8 |
| Salt | 7.6 | 7.6 |
| Savour flavour mix# | 24.1 | 24.1 |
| Sugar | 3.4 | 3.4 |
| Creamer (74% fat) | 43.8 | 43.8 |
| Fat (palm oil/fat) | 2.3 | 2.3 |
| Total (%) | 100.0 | 100.0 |

#powders: wine extract, flavourings, onion, yeast extract, lemon, pepper. The savoury flavour mix contains ~8 wt% NaCl by weight of the savoury flavour mix.

The total water content of the concentrate according to the invention was <5 wt % by weight of the total concentrate.

Surprisingly the concentrate according to the invention showed a marked decrease of 80% in lumping compared to the concentrate with native corn starch. The w/w ratio of of non-gelatinised starch to salt in the ex 3a was 1.5

Starch Characterization

Heat moisture treated potato starch and other comparative starches were analysed using RVA and DSC as described above. For the RVA analysis respectively 1.2 g native corn, 0.8 g of native potato, 1.2 g of native tapioca, 1 g of annealed tapioca starch and 0.9 g of waxy corn starch was used.

| | RVA | | | | DSC |
|---|---|---|---|---|---|
| | ViscRef | T1 | T2 | Delayed | RefTₒₙₛₑₜ |
| Comparative Starches | (cP) | (min) | (min) | swelling | (° C.) |
| Native potato | 206 | 6.7 | 4.9 | Yes | 61 |
| Native Tapioca | 243 | 4.0 | 3.7 | No | 75 |
| Annealed tapioca (S4) | 225 | 5.3 | 4.4 | No | 83 |
| Native corn | 237 | 5.4 | 4.9 | No | 75 |
| Native waxy corn | 262 | 5.0 | 3.8 | No | 73 |

### Example 4

### [Comparative] Sorbitol and Non-Gelatinised Starch

Example 1 of WO 2004/049822 discloses a liquid fluid thickener composition with 32% non-gelatinised starch and 43.4% sorbitol as shown below. As sorbitol is not acceptable for many consumers, an attempt was made to produce a thickener according to example 1 of WO 2004/049822 but without sorbitol.

| | Example 1 in |
|---|---|
| | WO004/049822 |
| | (g) |
| Sorbitol | 43.4 |
| Native potato | 32.0 |
| starch | |
| Water | 17.9 |
| Kitchen salt | 3.0 |
| Potassium acetate | 3.6 |
| Xanthan | 0.1 |
| TOTAL | 100 |

Without sorbitol the product could not be processed as the mixing equipment was blocked by the addition of the non-gelatinised starch.

1. A food concentrate comprising
a) less than 20 wt % of water by weight of the total food concentrate;
b) 3 to 70 wt % of salt by weight of the total food concentrate;
c) an effective amount of a taste booster selected from glutamate, 5′-ribonucleotides, sucrose, glucose, fructose, lactic acid, citric acid and mixtures thereof;
d) 10 to 75 wt % by weight of the total food concentrate of a delayed-swelling annealed non-gelatinised starch characterised by Ref Tonset of at least 70° C.

2. A food concentrate according to claim 1 wherein the non-gelatinised starch is annealed sago starch and/or annealed corn starch.

3. A food concentrate according to claim 1 wherein effective amount of taste booster is at most 40 wt %, more preferably of at most 30 wt %, more preferably in an amount at most 25 wt %, most preferably in an amount of at most 15 wt %, and preferably at least 0.1 wt %, more preferably at least 0.5 wt %, more preferably at least 1 wt %, more preferably at least 5 wt %, based on the weight of the total food concentrate.

4. A food concentrate according to claim 1 having a w/w ratio of non-gelatinised starch to salt in the total food concentrate of preferably at least 0.8, even more preferably at least 1, even more preferably at least 1.5, even more preferably at least 2, and more preferably at most 10, more preferably at most 8, most preferably at most 5.

5. A food concentrate according to claim 1 wherein the food concentrate has a water activity of less than 0.65, preferably less than 0.5 more preferably less than 0.4 more preferably less than 0.3 and preferably more than 0.15.

6. A food concentrate according to claim 1 wherein the food concentrate comprises 5 to 40 wt % of salt by weight of the total food concentrate.

7. A food concentrate according to claim 1 comprising less than 5 wt %, preferably less than 3 wt %, more preferably less than 1 wt % of a sorbitol by weight of the total food concentrate.

8. A food concentrate according to claim 1 wherein the food concentrate provides a ready-to-eat product having viscosity of at least 10 mPa·s, preferably at least 20 mPa·s, more preferably at least 30 mPa·s, most preferably at least 50 mPa·s at 60° C., wherein preferably said ready-to eat product is a soup, sauce or gravy.

9. A food concentrate according to claim 1 comprising
a) less than 20 wt % of water by weight of the total food concentrate;
b) 3 to 70 wt % of salt by weight of the total food concentrate;
c) 1 to 40 wt % by weight of the total food concentrate of a taste booster selected from glutamate, 5′-ribonucleotides, sucrose, glucose, fructose, lactic acid, citric acid and mixtures thereof;
d) 10 to 75 wt % by weight of the total food concentrate of a delayed-swelling annealed non-gelatinised starch characterised by Ref Tonset of at least 70° C.; wherein the non-gelatinised starch is annealed sago starch and/or annealed corn starch;
e) having a w/w ratio of non-gelatinised starch to salt in the total food concentrate of 1 to 5;
f) having a water activity of less than 0.4 more preferably less than 0.3 and more than 0.15;
wherein the food concentrate provides a ready-to-eat product having viscosity of, preferably at least 20 mPa·s, more preferably at least 30 mPa·s, most preferably at least 50 mPa·s at 60° C., wherein said ready-to eat product is a soup, sauce or gravy.

10. A food concentrate according to claim 1 wherein the food concentrate shows a reduction in lumping in the test described herein of at least 15%, more preferably at least 20%, more preferably at least 30%, more preferably at least 40%, more preferably at least 50% and preferably at most 100% when compared to the same concentrate except that the starch according to invention is replaced by the native starch from the same botanical source.

11. A process for preparing a food concentrate according to claim 1 preferably comprising
a) less than 20 wt % of water by weight of the total food concentrate;
b) 3 to 70 wt % of salt by weight of the total food concentrate;
c) an effective amount of a taste booster selected from glutamate, 5′-ribonucleotides, sucrose, glucose, fructose, lactic acid, citric acid and mixtures thereof;
d) 10 to 75 wt % of a delayed-swelling annealed non-gelatinised starch characterised by Ref Tₒₙₛₑₜ of at least 70° C.;
the process comprising the steps of:
i) preparing a mixture comprising:
the salt, taste booster and the non-gelatinised starch
ii) optionally, filling the mixture of step iii) into a packaging.

12. A food concentrate obtainable by a process according to claim 1.

13. Use of a food concentrate according to claim 1 to prepare a soup, a sauce or a gravy.

14. A process to provide a ready-to-eat food product, comprising the steps of:
a) providing a food concentrate according to claim 1,
b) admixing at least part of the food concentrate to an aqueous phase,
c) heating the mixture resulting from step b) to a temperature higher than the Ref Tₒₙₛₑₜ of the starch used, such as to achieve a viscosity increase of the mixture to result in a ready-to-eat food product, whereby the dilution in step b) is preferably between 20 g/L and 350 g/L and more preferably between 50 and 250 g/L.
